(19) United States
(12) Patent Application Publication
(10) Pub. No.: US 2025/0141507 A1
(43) Pub. Date: May 1, 2025

(54) PATH LOSS AWARE BEAM PATTERN SYNTHESIS FOR WIDE COVERAGE BEAMS

(71) Applicant: QUALCOMM Incorporated, San Diego, CA (US)

(72) Inventors: Wenquan HU, Espoo (FI); Mark WALLACE, Bedford, MA (US); Sami Jukka HOISKO, Helsinki (FI)

(21) Appl. No.: 18/498,907

(22) Filed: Oct. 31, 2023

(51) Int. Cl. H04B 7/06

(52) U.S. Cl. CPC H04B 7/0617; H04B 7/0632

(57) ABSTRACT

Methods, systems, and devices for wireless communication are described. For instance, a network entity may receive control information indicating a set of candidate geolocations within a target coverage area for the network entity. The network entity may transmit a signal that is beamformed via a set of antenna elements of an antenna array of the network entity in accordance with a set of antenna beamforming weights. The set of antenna beamforming weights may be identified based on a beam pattern performance criterion applied to a set of candidate radiation patterns of a spatial envelope model. The spatial envelope model may be based on a set of directions between the antenna array of the network entity and the set of candidate geolocations as well as a set of pathloss values associated with the set of candidate geolocations.

### FIELD OF TECHNOLOGY

The following relates to wireless communication, including path loss aware beam pattern synthesis for wide coverage beams.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a network entity may transmit a broadcast transmission to a set of UEs. If a UE of the set of UEs is outside of a coverage area of the network entity, the broadcast transmission may not reach the UE. One technique to enable the UE to receive the broadcast transmission may include the network entity increasing a transmit power of the broadcast transmission. However, increasing the transmit power of the broadcast transmission may increase energy consumed by the network entity.

### SUMMARY

The described techniques relate to improved methods, systems, devices, and apparatuses that support path loss aware beam pattern synthesis for wide coverage beams. For example, the described techniques provide for a network entity to improve a coverage area for a wide beam broadcast transmission. For instance, a network entity may receive control information indicating a set of candidate geolocations within a target coverage area for the network entity. The network entity may transmit a signal that is beamformed via a set of antenna elements of an antenna array of the network entity in accordance with a set of antenna beamforming weights. The set of antenna beamforming weights may be identified based on a beam pattern performance criterion applied to a set of candidate radiation patterns of a spatial envelope model. The spatial envelope model may be based on a set of directions between the antenna array of the network entity and the set of candidate geolocations as well as a set of pathloss values associated with the set of candidate geolocations.

A method for wireless communications by a network entity is described. The method may include receiving control information indicating a set of multiple candidate geolocations within a target coverage area for the network entity and transmitting a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

A network entity for wireless communications is described. The network entity may include one or more memories storing processor executable code, and one or more processors coupled with the one or more memories. The one or more processors may individually or collectively operable to execute the code to cause the network entity to receive control information indicating a set of multiple candidate geolocations within a target coverage area for the network entity and transmit a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

Another network entity for wireless communications is described. The network entity may include means for receiving control information indicating a set of multiple candidate geolocations within a target coverage area for the network entity and means for transmitting a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

A non-transitory computer-readable medium storing code for wireless communications is described. The code may include instructions executable by a processor to receive control information indicating a set of multiple candidate geolocations within a target coverage area for the network entity and transmit a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

In some examples of the method, network entities, and non-transitory computer-readable medium described herein, a set of multiple pattern correlation coefficients may be identified between a target radiation pattern for the target coverage area and a respective candidate radiation pattern of the set of multiple candidate radiation patterns and the beam pattern performance criterion corresponds to one of the set of multiple candidate radiation patterns having a pattern correlation coefficient of the set of multiple pattern correlation coefficients that satisfies a threshold.

In some examples of the method, network entities, and non-transitory computer-readable medium described herein, the set of multiple antenna beamforming weights correspond to the one of the set of multiple candidate radiation patterns that may have the pattern correlation coefficient that satisfies the threshold.

In some examples of the method, network entities, and non-transitory computer-readable medium described herein, the pattern correlation coefficient satisfying the threshold includes the pattern correlation coefficient being higher than each other pattern correlation coefficient of the set of multiple pattern correlation coefficients.

In some examples of the method, network entities, and non-transitory computer-readable medium described herein, a set of multiple power gain values may be identified for the set of multiple candidate radiation patterns and the beam pattern performance criterion corresponds to one of the set of multiple candidate radiation patterns having a power gain value of the set of multiple power gain values that satisfies a power gain threshold in the target coverage area.

In some examples of the method, network entities, and non-transitory computer-readable medium described herein, the set of multiple antenna beamforming weights correspond to the one of the set of multiple candidate radiation patterns having the power gain value that satisfies the power gain threshold for the target coverage area.

In some examples of the method, network entities, and non-transitory computer-readable medium described herein, each power gain value of the set of multiple power gain values corresponds to a minimum power gain value for a respective candidate radiation pattern in the target coverage area of the set of multiple candidate radiation patterns.

In some examples of the method, network entities, and non-transitory computer-readable medium described herein, the power gain value satisfying the power gain threshold includes the power gain value being higher than each other power gain value of the set of multiple power gain values.

In some examples of the method, network entities, and non-transitory computer-readable medium described herein, the signal may be transmitted via a first frequency band and the method, apparatuses, and non-transitory computer-readable medium may include further operations, features, means, or instructions for transmitting a second signal via a second frequency band that may be beamformed via the set of multiple antenna elements of the antenna array of the network entity in accordance with a second set of multiple antenna beamforming weights, where the second set of multiple antenna beamforming weights may be identified based on the beam pattern performance criterion applied to a second set of multiple candidate radiation patterns of the spatial envelope model.

In some examples of the method, network entities, and non-transitory computer-readable medium described herein, each candidate radiation pattern of the set of multiple candidate radiation patterns may be associated with a first carrier wave and each candidate radiation pattern of the second set of multiple candidate radiation patterns may be associated with a second carrier wave that may be different from the first carrier wave.

In some examples of the method, network entities, and non-transitory computer-readable medium described herein, the spatial envelope model may be based on a pathloss compensation coefficient that indicates the set of multiple pathloss values associated with the set of multiple candidate geolocations.

In some examples of the method, network entities, and non-transitory computer-readable medium described herein, the set of multiple candidate radiation patterns of the spatial envelope model may be based on the set of multiple pathloss values associated with the set of multiple candidate geolocations.

### BRIEF DESCRIPTION OF THE DRAWINGS

FIG. 1 shows an example of a wireless communications system that supports path loss aware beam pattern synthesis for wide coverage beams in accordance with one or more aspects of the present disclosure.

FIG. 2 shows an example of a wireless communications system that supports path loss aware beam pattern synthesis for wide coverage beams in accordance with one or more aspects of the present disclosure.

FIG. 3 shows an example of a candidate radiation pattern selection scheme that supports path loss aware beam pattern synthesis for wide coverage beams in accordance with one or more aspects of the present disclosure.

FIG. 4 shows an example of a process flow that supports path loss aware beam pattern synthesis for wide coverage beams in accordance with one or more aspects of the present disclosure.

FIGS. 5 and 6 show block diagrams of devices that support path loss aware beam pattern synthesis for wide coverage beams in accordance with one or more aspects of the present disclosure.

FIG. 7 shows a block diagram of a communications manager that supports path loss aware beam pattern synthesis for wide coverage beams in accordance with one or more aspects of the present disclosure.

FIG. 8 shows a diagram of a system including a device that supports path loss aware beam pattern synthesis for wide coverage beams in accordance with one or more aspects of the present disclosure.

FIG. 9 shows a flowchart illustrating methods that support path loss aware beam pattern synthesis for wide coverage beams in accordance with one or more aspects of the present disclosure.

### DETAILED DESCRIPTION

A network entity may transmit a broadcast transmission (e.g., a synchronization signal/physical broadcast channel (SSB) transmission) via multiple beams. Transmitting a broadcast transmission over multiple narrow beams may be less power-efficient and associated with increased complexity as compared to transmitting the broadcast transmission over a wide beam (e.g., a single beam over a wide coverage area) to cover each candidate user equipment (UE) in a wide area of a cell.

In order to enable more targeted coverage for wide beam broadcast transmissions from the network entity, the network entity may determine a set of antenna beamforming weights for a broadcast transmission by applying a beam pattern performance criterion to a set of candidate radiation patterns of a spatial envelope model. For instance, the network entity may identify a spatial envelope model, where the spatial envelope model may be a function of a maximum distance or range of a UE in different directions relative to an antenna panel of the network entity. The network entity may identify the spatial envelope model by receiving control information indicating multiple candidate geolocations that a UE may be present in. The network entity may apply a beam pattern performance criterion to a set of candidate radiation patterns of a spatial envelope mode, where the spatial envelope model is based on a set of directions between the antenna array of the network entity and the set of geolocations as well as a set of pathloss values associated with the set of candidate geolocations. By applying the beam pattern performance criterion, the network entity may determine a set of antenna beamforming weights and may transmit (e.g., via a wide transmission beam) a signal (e.g., a broadcast transmission) that is beamformed via a set of antenna elements of the antenna array in accordance with the determined set of antenna beamforming weights. By considering the set of geolocations when applying the beam pattern performance criterion, the resulting beam used for the signal may be more targeted as compared to a predefined beam being used for the signal.

Aspects of the disclosure are initially described in the context of wireless communications systems. Additional aspects of the disclosure are described in the context of a candidate radiation pattern selection scheme and a process flow. Aspects of the disclosure are further illustrated by and described with reference to apparatus diagrams, system diagrams, and flowcharts that relate to path loss aware beam pattern synthesis for wide coverage beams.

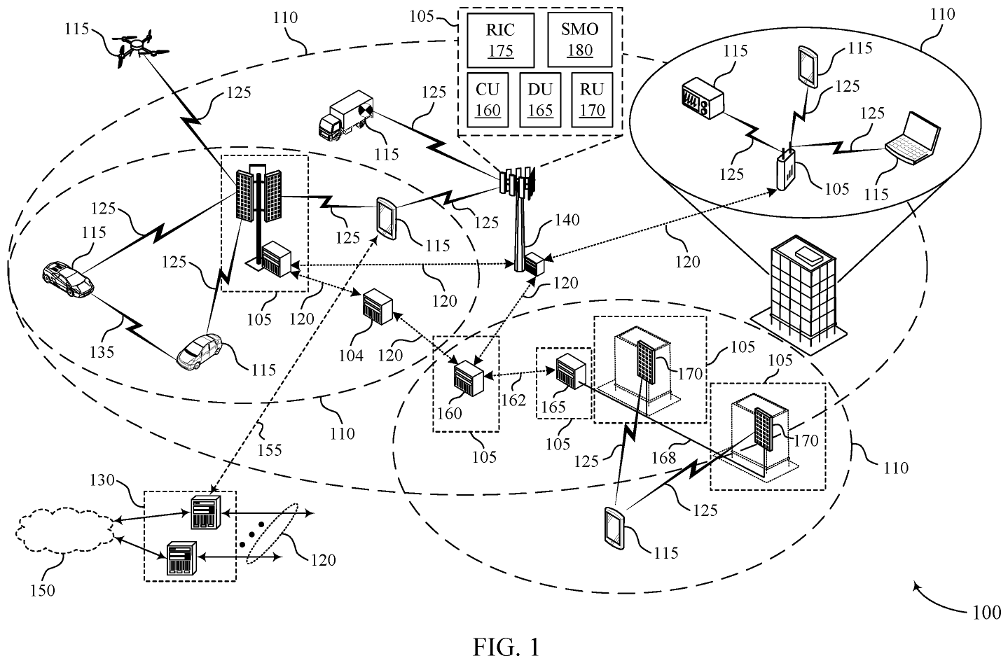

FIG. 1 shows an example of a wireless communications system 100 that supports path loss aware beam pattern synthesis for wide coverage beams in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support path loss aware beam pattern synthesis for wide coverage beams as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) with multiple antenna elements to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a first network entity 105, a first UE 115) along a single beam direction (e.g., a direction associated with the receiving device, such as a second network entity 105 or a second UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity 105 may transmit a broadcast transmission (e.g., a synchronization SSB transmission) via multiple beams. Transmitting a broadcast transmission over multiple beams may be less power-efficient and associated with increased complexity as compared to transmitting the broadcast transmission over a wide beam (e.g., a single beam over a wide coverage area) to cover each candidate UE 115 in a wide area of a cell.

The techniques described herein may enable a network entity 105 to improve coverage for a broadcast transmission when transmitting over a beam to cover a wide spatial area (e.g., when transmitting over a single wide beam). For instance, the network entity 105 may identify a spatial envelope model, where the spatial envelope model may be a function of a maximum distance or range of a UE 115 in different directions relative to an antenna panel of the network entity 105. The network entity 105 may identify the spatial envelope model by receiving control information indicating multiple candidate geolocations that a UE 115 may be present in. The network entity 105 may apply a beam pattern performance criterion to a set of candidate radiation patterns of a spatial envelope mode, where the spatial envelope model is based on a set of directions between the antenna array of the network entity 105 and the set of geolocations as well as a set of pathloss values associated with the set of candidate geolocations. By applying the beam pattern performance criterion, the network entity 105 may determine a set of antenna beamforming weights and may transmit (e.g., via a wide transmission beam) a signal (e.g., a broadcast transmission) that is beamformed via a set of antenna elements of the antenna array in accordance with the determined set of antenna beamforming weights. In some examples, the network entity 105 may determine different beamforming weights for different frequency ranges over which the broadcast transmission is sent.

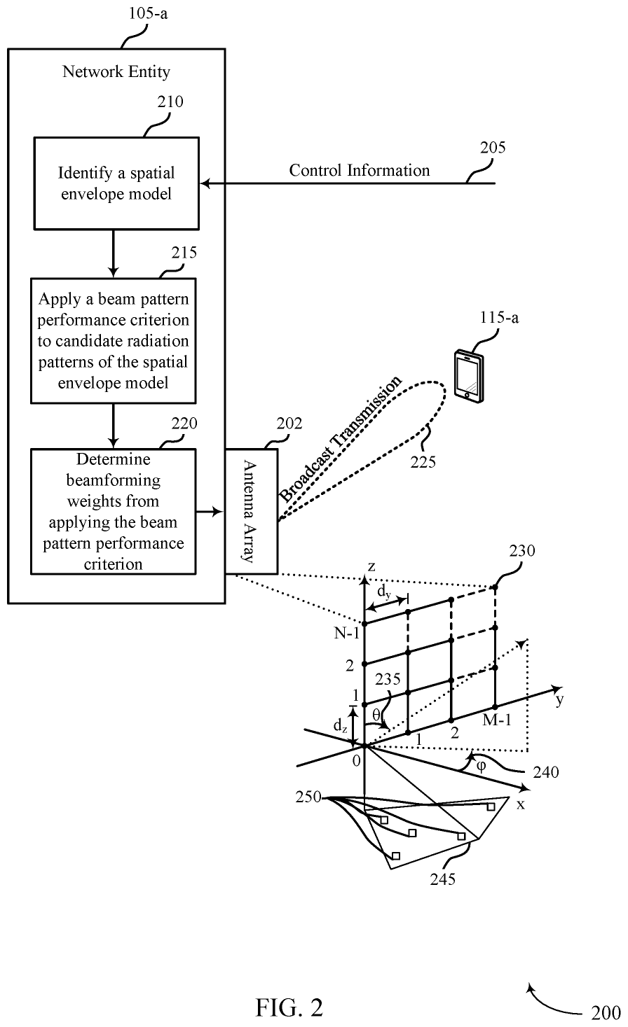

FIG. 2 shows an example of a wireless communications system 200 that supports path loss aware beam pattern synthesis for wide coverage beams in accordance with one or more aspects of the present disclosure. In some examples, wireless communications system 200 may be implemented by one or more aspects of wireless communications system 100. For instance, UE 115-a may be an example of a UE 115 as described with reference to FIG. 1 and network entity 105-a may be an example of a network entity 105 as described with reference to FIG. 1.

Network entity 105-a may receive control information 205 that indicates a set of candidate geolocations 250 within a target coverage area 245 for network entity 105-a. Each candidate geolocation within the set of candidate geolocations 250 may correspond to a different location of a UE at which a signal strength associated with transmissions received by the UE is at or above a threshold amount of power.

Using control information 205, network entity 105-a may identify a spatial envelope model at 210. For instance, network entity 105-a may determine a spatial envelope model based on a set of directions between an antenna array 202 of network entity 105-a and the set of candidate geolocations 250. For instance, each candidate geolocation within the set of candidate geolocations 250 may be in a different direction relative to the antenna array 202 (e.g., an antenna panel) and the network entity 105-a may determine a range of directions corresponding to the candidate geolocations 250 (e.g., in zenith 235 and azimuth 240) based on the directions of the candidate geolocations 250 relative to the antenna array 202. Additionally, network entity 105-a may determine the spatial envelope model based on a set of pathloss values associated with the set of candidate geolocations 250. For instance, network entity 105-a may determine a pathloss coefficient that indicates the set of pathloss values associated with the set of candidate geolocations 250.

At 215, network entity 105-a may apply a beam pattern performance criterion to candidate radiation patterns of the spatial envelope model. For instance, network entity 105-a may determine a target radiation pattern and/or a generated radiation pattern. The target radiation pattern and/or generated radiation pattern may correspond to beamforming transmission of a signal or a message using a wide transmission beam (e.g., a single transmission beam over a wide coverage area), and the beam pattern performance criterion may be used to identify a set of antenna beamforming weights for a beam radiation pattern, from amongst a set of possible candidate beam radiation patterns, such that UEs positioned at the various different geolocations would each receive the signal or the message at a sufficient power level. The network entity 105-a may model pathloss impact for the spatial envelope model in the target radiation pattern or the generated radiation pattern. In the former case, the network entity 105-a may apply the beam pattern performance criterion, which may be to maximize a pattern correlation coefficient between the target radiation pattern and the generated radiation pattern. In the latter case, network entity 105-a may apply the beam pattern performance criterion by maximizing a minimum power gain of the generated radiation pattern within target coverage area 245.

At 220, network entity 105-a may determine beamforming weights from applying the beam pattern performance criterion. In some examples, each beamforming weight may be determined for each antenna element 230 of the antenna array 202 and each polarization for the antenna element 230. For instance, if antenna array 202 is a rectangular array with M*N antenna elements 230 over N rows and M columns in one polarization, and if there are P polarizations (e.g., a +45 degrees polarization and a −45 degrees polarization), then P*M*N beamforming weights may be determined from applying the beam pattern performance criterion. In some examples, the antenna array 202 may have a uniform spacing, with a distance d_{z} between each antenna element in the z direction (e.g., between each row of the antenna array 202) and a distance d_{y} between each antenna element in the u direction (e.g., between each column of the antenna array 202).

The antenna array 202 of network entity 105-a may transmit a broadcast transmission 225 to UE 115-a in accordance with the determined beamforming weights. Network entity 105-a may transmit the broadcast transmission 225 over a wide beam (e.g., a single wide beam). UE 115-a may receive the broadcast transmission 225.

Determining the beamforming weights in the manner described herein may enable network entity 105-a to have more targeted coverage associated with transmitting a broadcast transmission 225 over a wide beam while also having a reduced complexity and/or reduced power consumption as compared to transmitting the broadcast transmission 225 over multiple beams (e.g., due to a reduced duration of an always-on signal transmission).

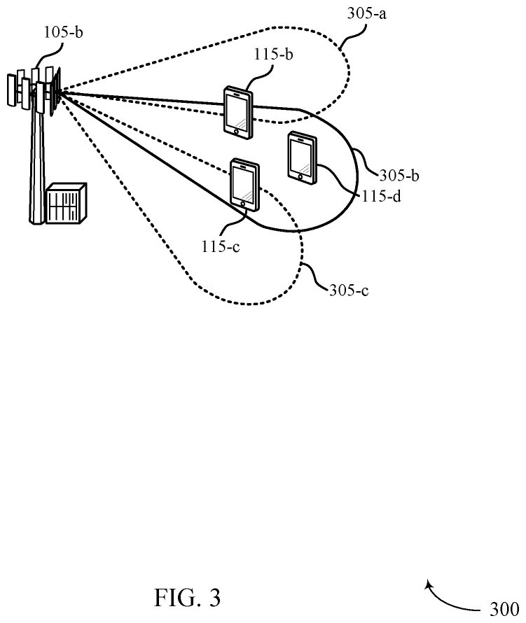

FIG. 3 shows an example of a candidate radiation pattern selection scheme 300 that supports path loss aware beam pattern synthesis for wide coverage beams in accordance with one or more aspects of the present disclosure. Candidate radiation pattern selection scheme 300 may be implemented by one or more aspects of wireless communications systems 100 and/or 200. For instance, network entity 105-b may be an example of a network entity 105 as described with reference to FIG. 1 and/or network entity 105-a as described with reference to FIG. 1. Additionally, or alternatively, UEs 115-b, 115-c, and 115-d may each be an example of a UE 115 as described with reference to FIG. 1 and/or UE 115-a as described with reference to FIG. 2.

As described herein, network entity 105-b may determine a set of beamforming weights for transmitting a broadcast transmission to UEs 115-b, 115-c, and 115-d based on applying a beam pattern performance criterion to a set of candidate radiation patterns. For instance, the set of candidate radiation patterns may include candidate radiation pattern 305-a, 305-b, and 305-c. By applying the beam pattern performance criterion, network entity 105-b may transmit the broadcast transmission using beamforming weights corresponding to candidate radiation pattern 305-b (e.g., beamforming weights that produce candidate radiation pattern 305-b), as candidate radiation pattern 305-b may be associated with a maximized pattern correlation coefficient with a target radiation pattern relative to other candidate radiation patterns (e.g., candidate radiation patterns 305-a and 305-c). For instance, candidate radiation pattern 305-b may have a higher pattern correlation coefficient with a target radiation pattern as compared to candidate radiation patterns 305-a and 305-c. Additionally, or alternatively, candidate radiation pattern 305-b may be associated with a maximized minimum power gain for a target coverage area relative to other candidate radiation patterns (e.g., candidate radiation patterns 305-a and 305-c). For instance, candidate radiation pattern 305-b may have a higher minimum power gain for a target coverage areas as compared to candidate radiation patterns 305-a and 305-c.

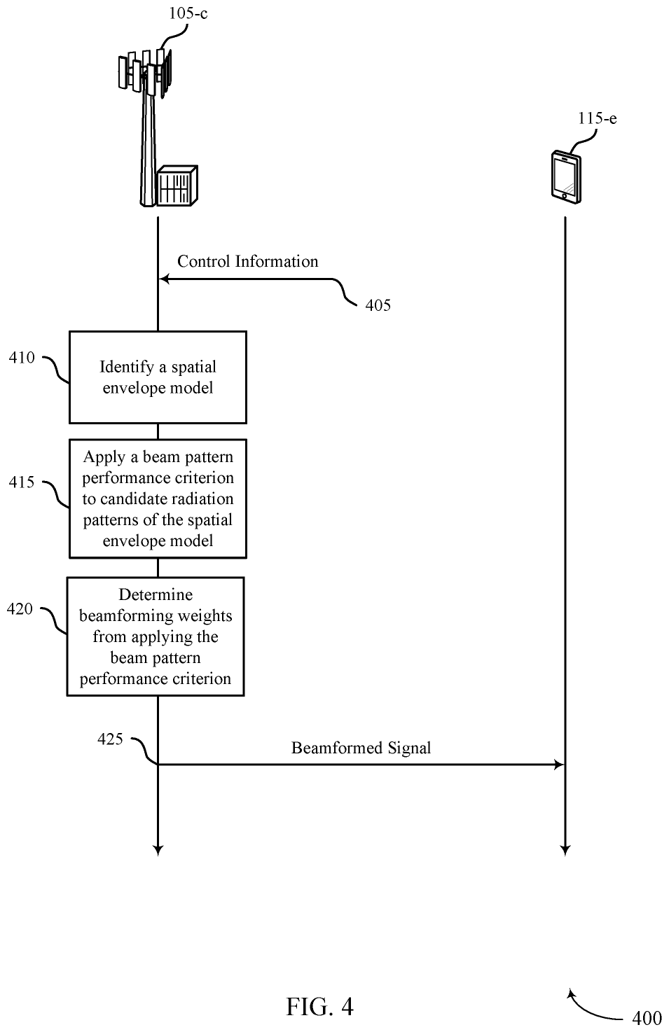

FIG. 4 shows an example of a process flow 400 that supports path loss aware beam pattern synthesis for wide coverage beams in accordance with one or more aspects of the present disclosure. In some examples, process flow 400 may be implemented by one or more aspects of FIGS. 1 through 3. For instance, network entity 105-c may be an example of a network entity 105 as described with reference to FIG. 1, a network entity 105-a as described with reference to FIG. 2, or a network entity 105-b as described with reference to FIG. 3. Additionally, or alternatively, UE 115-e may be an example of a UE 115 as described with reference to FIG. 1; a UE 115-a as described with reference to FIG. 2; or any of UE 115-b, 115-c, or 115-d as described with reference to FIG. 3.

NR may support flexible beamforming schemes for broadcast transmissions (e.g., SSB transmissions). Based on different carrier frequencies and cell deployment scenarios, single beam or multi beam based broadcast transmissions may be configured in an NR network (e.g., a network including network entity 105-c). Compared with multi-beam based broadcast transmissions schemes, which may have a higher beamforming gain in coverage limited scenarios, single-beam based broadcast transmission schemes may have more simplicity and better power-efficiency due to network entity 105-c transmitting a broadcast transmission for a shorter duration and UE 115-e having a shorter monitoring window length. The techniques described herein may enable network entity 105-c to form a cell wide beam pattern to cover UEs located at any spot within a predefined cell coverage area.

The techniques described herein may enable network entity 105-c to utilize a wide beam pattern via an antenna panel of network entity 105-c (e.g., a dual-polarized large-size uniform rectangular antenna panel). In some examples, the antenna panel may have M columns of antenna elements (e.g., M=8), N rows of antenna elements (e.g., N=4), and P polarizations per antenna element (e.g., P=2) for broadcast channel transmission and reception. For instance, the antenna panel may be used for communicating an SSB, a system information block (SIB), a paging channel carried on a physical downlink control channel (PDCCH) or a physical downlink shared channel (PDSCH), a physical random access channel (PRACH) transmission, or a sounding reference signal (SRS).

The techniques described herein may account for pathloss in different directions when performing wide coverage beam pattern synthesis. Compared with other forms of phase-only beamforming, the techniques described herein may enable improved cell coverage in a wide coverage beam configuration by adapting a spatial beam pattern with a spatial envelope which is defined as a maximum distance or range of potential UE locations (e.g., candidate geolocations) at various directions (e.g., in azimuth, in zenith) in a cell. The spatial envelope may correspond to a surface of UE locations indicating where a UE (e.g., UE 115-e) may experience a predefined signal strength (e.g., a lowest signal strength at which the UE may still receive a broadcast transmission) in a particular spatial direction. By accounting for the pathloss impact along with angle domain considerations in a beam pattern, the techniques described herein may improve wide beam coverage without forfeiting simplicity and power saving benefits of wide coverage beam configurations.

At 405, network entity 105-c may receive control information indicating a set of candidate geolocations within a target coverage area for network entity 105-c. Network entity 105-c may receive the control information from one or more of a set of UEs or another network device (e.g., a network entity, a user plane entity). Each candidate geolocation within the set of candidate geolocations may correspond to a maximum distance or a maximum range of a set of UEs relative to antenna array for a respective direction of the set of directions (e.g., a location where a UE may experience a lowest signal strength).

At 410, network entity 105-c may identify a spatial envelope model based on a set of directions between the antenna array of network entity 105-c and the set of candidate geolocations. For instance, the spatial envelope model may be defined using a spatial envelope function Env (θ, φ) in azimuth θ and zenith φ respectively. Additionally, the spatial envelope model may be based on a pathloss compensation coefficient (e.g., a pathloss compensation coefficient that indicates a set of pathloss values associated with the set of candidate geolocations). For instance, the spatial envelope model may be based on a pathloss compensation coefficient a. Network entity 105-c may model the pathloss impact by accounting for the spatial envelope function Env (θ, φ) and the pathloss compensation coefficient α in a target radiation pattern or a candidate radiation pattern (e.g., a generated radiation pattern, a power pattern with pathloss term impact).

In a first example (e.g., in which the pathloss impact is modeled in the target radiation pattern), a target beam to cover a spatial domain pre-defined by particular ranges of azimuth (e.g., |φ|≤60°) and zenith (e.g., 92°≤θ≤120°) may be used to define a target power pattern while taking pathloss compensation into account. For instance, a target power pattern may be modeled as:

$${G}_{T \_ PL} ( θ , φ ) = \{ \begin{matrix}{( Env ( θ , φ ) )}^{a} , \vert φ \vert \leq 60 ° and 92 ° < θ < 120 ° \\ 0 , others\end{matrix} \qquad ( 1 )$$

where (Env (θ, φ))^{a} is a pathloss related compensation factor and where the pathloss compensation coefficient α∈[2, 4] may be a predefined parameter according to measured channel statistics (e.g., a=2.2 in an urban macro cell deployment in a 3.5 GHz carrier frequency). In some examples, Env (θ, φ)=rₘₐₓ (θ, φ), where rₘₐₓ(θ, φ) is a maximum range of any UE (e.g., any candidate geolocation) which is at direction (θ, φ) in a target deployment scenario. In some examples, a 3D distance between network entity 105-c and any UE (e.g., UE 115-e) may be given as

$${d}_{3 D} = \frac{- ( {h}_{BS} - {h}_{UE} )}{cos θ} ,$$

which may be a function of zenith angle θ, where h_{BS} is a height of network entity 105-c and where h_{UE} is a UE height assuming cell coverage is defined on a flat surface (e.g., h_{BS}=25 m and h_{UE}=1.5 m). By removing the constants, the pathloss related compensation function may be written as:

$${( Env ( θ , φ ) )}^{a} = {( \frac{1}{- cos θ} )}^{a} , \qquad ( 2 )$$

$$92 ° < θ < 120 ° ,$$

$$a > 0.$$

Accordingly, by utilizing equation (1) and equation (2) (e.g., an assuming a=2.2), the fully pathloss compensated target power pattern may be modeled as:

$${G}_{T \_ PL} ( θ , φ ) = \{ \begin{matrix}{( \frac{1}{- cos θ} )}^{2.2} , \vert φ \vert \leq 60 ° and 92 ° < θ < 120 ° \\ 0 , others\end{matrix} \qquad ( 3 )$$

In order to partially compensate for pathloss, the value of the pathloss compensation coefficient a may be tuned to a smaller positive value. For instance, if a is tuned to 0.5, then the partially compensated target power pattern may be modeled as:

$${G}_{T \_ PL} ( θ , φ ) = \{ \begin{matrix}{( \frac{1}{- cos θ} )}^{0.5} , \vert φ \vert \leq 60 ° and 92 ° < θ < 120 ° \\ 0 , others\end{matrix} \qquad ( 4 )$$

In a second example (e.g., in which the pathloss impact is modeled in the candidate radiation pattern), the candidate radiation pattern (e.g., a power pattern) including a distance of the array (e.g., a distance from the array to a UE) in free space assuming a far field distance r may be written as:

$${P}_{T} ( θ , φ , r ) = \frac{1}{2 {r}^{2}} {\vert {f}_{p 45} ( θ , φ ) \vert}^{2} ( {\vert {\sum }_{m , n} ( {A}_{mn \_ P} + {A}_{mn \_ N} ) {e}^{jk ( {md}_{y} sin θ sin φ + {nd}_{z} cos θ )} \vert}^{2} + {\vert {\sum }_{m , n} ( {A}_{mn \_ P} - {A}_{mn \_ N} ) {e}^{jk ( {md}_{y} sin θ sin φ + {nd}_{z} cos θ )} \vert}^{2} ) \qquad ( 5 )$$

where fₚ₄₅ (θ, φ) is an element field pattern of the antenna element at the mth and nth antenna element position within the array (e.g., which may have a same value for two orthogonal polarizations), k is a wavenumber on a center subcarrier of a signal, d_{y} is an element distance in a y direction (e.g., as depicted in FIG. 2), and d_{z} is an element distance in a z direction (e.g., as depicted in FIG. 2). By obtaining the spatial envelope of potential UE locations (e.g., candidate geolocations) denoted by Env (θ, φ)=rₘₐₓ (θ, φ) (e.g., a maximum range of any UE which is at direction (θ, φ)), network entity 105-c may define the candidate radiation pattern as:

$${P}_{T} ( θ , φ , Env ( θ , φ ) ) = \frac{{\vert {f}_{p 45} ( θ , φ ) \vert}^{2}}{{( Env ( θ , φ ) )}^{a}} ( {\vert {\sum }_{m , n} {A}_{mn \_ P} {e}^{jk ( {md}_{y} sin θ sin φ + {nd}_{z} cos θ )} \vert}^{2} + {\vert {\sum }_{m , n} {A}_{mn \_ N} {e}^{jk ( {md}_{y} sin θ sin φ + {nd}_{z} cos θ )} \vert}^{2} ) \qquad ( 6 )$$

$$where$$

$$\frac{1}{{( Env ( θ , φ ) )}^{a}} is a pathloss related term .$$

At 415, network entity 105-c may apply a beam pattern performance criterion to a set of candidate radiation patterns of the spatial envelope model. In some examples, the set of pattern correlation coefficients may be identified between a target radiation coverage area and a respective candidate radiation pattern of the set of candidate radiation patterns. In such examples, the beam pattern performance criterion may correspond to one of the set of candidate radiation patterns having a pattern correlation coefficient of the set of pattern correlation coefficients that satisfies a threshold. In some examples, the pattern correlation coefficient satisfying the threshold includes the pattern correlation coefficient being higher than each other pattern correlation coefficient of the set of pattern correlation coefficients.

For instance, the beam pattern performance criterion may include maximizing a pattern correlation coefficient between a target radiation pattern and a generated radiation pattern, from which network entity 105-c may derive a corresponding optimization problem. For instance, by sampling a spatial domain of (θ, φ) into discrete values, a cost function of antenna beamforming weights may be defined as:

$$( 7 )$$

$$J ( {A}_{mn \_ P} , {A}_{mn \_ N} ) = \frac{- {\sum }_{θ , φ} ( {P}_{T} ( θ , φ ) * {G}_{T \_ PL} ( θ , φ ) )}{\sqrt{{\sum }_{θ , φ} ( {P}_{T} ( θ , φ ) * {P}_{T} ( θ , φ ) )} \sqrt{{\sum }_{θ , φ} ( {G}_{T \_ PL} ( θ , φ ) * {G}_{T \_ PL} ( θ , φ ) )}} ,$$

$$\vert φ \vert \leq 90 °$$

$$and$$

$$0 ° < θ < 180 °$$

where G_{T_PL} (θ, φ) is a target radiation pattern (e.g., a target radiation pattern corresponding to any of equations (1), (3), or (4)), P_{T} (θ, φ) is a candidate radiation pattern (e.g., a generated radiation pattern corresponding to equation (8) herein), A_{mn_P} is an antenna beamforming weight for an antenna element at an mth and nth antenna element position with a first polarization (e.g., +45 degrees), and A_{mn_N} is an antenna beamforming weight for an antenna element at an mth and nth antenna element position (e.g., an mth column and an nth row of the array) with a second polarization (e.g., −45 degrees). In such examples, the candidate radiation pattern P_{T} (θ, φ) (e.g., the generated radiation pattern) may be written as:

$$( 8 )$$

$${P}_{T} ( θ , φ ) = \frac{1}{2} {\vert {f}_{p 45} ( θ , φ ) \vert}^{2} ( {\vert {\sum }_{m , n} ( {A}_{mn \_ P} + {A}_{mn \_ N} ) {e}^{jk ( {md}_{y} sin θ sin φ + {nd}_{z} cos θ )} \vert}^{2} + {\vert {\sum }_{m , n} ( {A}_{mn \_ P} - {A}_{mn \_ N} ) {e}^{jk ( {md}_{y} sin θ sin φ + {nd}_{z} cos θ )} \vert}^{2} ) = {\vert {f}_{p 45} ( θ , φ ) \vert}^{2} ( {\vert {\sum }_{m , n} {A}_{mn \_ P} {e}^{jk ( {md}_{y} sin θ sin φ + {nd}_{z} cos θ )} \vert}^{2} + {\vert {\sum }_{m , n} {A}_{mn \_ N} {e}^{jk ( {md}_{y} sin θ sin φ + {nd}_{z} cos θ )} \vert}^{2} )$$

where fₚ₄₅ (θ, φ) is an element field pattern of the antenna element at the mth and nth antenna element position (e.g., which may have a same value for two orthogonal polarizations), k is a wavenumber on a center subcarrier of a signal, d_{y} is an element distance in a y direction (e.g., as depicted in FIG. 2), and d_{z} is an element distance in a z direction (e.g., as depicted in FIG. 2). Optimized antenna beam weights corresponding to equation (8) may be defined as:

$${A}_{opt} = arg {min}_{{A}_{mn \_ P} , {A}_{mn \_ N}} ( J ( {A}_{mn \_ P} , {A}_{mn \_ N} ) ) \qquad ( 9 )$$

which may be subject to A_{mn_P}=e^{jϕ}^{_{mn_P}} and A_{mn_N}=e^{jϕ}^{_{nm_N}}.

In other examples, a set of power gain values may be identified for the set of candidate radiation patterns and the beam pattern performance criterion may correspond to one of the set of candidate radiation patterns having a power gain value of the set of power gain values that satisfies a power gain threshold in the target coverage area. Each power gain value of the set of power gain values may correspond to a minimum power gain value for a respective candidate radiation pattern in the target coverage area of the set of candidate radiation patterns. The power gain value satisfying the power gain threshold may include the power gain value being higher than each other power gain value of the set of power gain values.

For instance, the beam pattern performance criterion may include maximizing a minimum power gain of a candidate radiation pattern (e.g., a generated radiation pattern) in a target coverage area, from which network entity 105-c may derive an optimization problem. In some such examples, a cost function (e.g., an object function) may be defined as:

$$( 10 )$$

$$J ( {A}_{{mn}_{P}} , {A}_{{mn}_{N}} ) = {min}_{θ , φ} ( {P}_{T} ( θ , φ , Env ( θ , φ ) ) ) = {min}_{θ , φ} ( \frac{{\vert {f}_{p 45} ( θ , φ ) \vert}^{2}}{{( Env ( θ , φ ) )}^{a}} \text{} ( {\vert {\sum }_{m , n} {A}_{mn \_ P} {e}^{jk ( {md}_{y} sin θ sin φ + {nd}_{z} cos θ )} \vert}^{2} + {\vert {\sum }_{m , n} {A}_{mn \_ N} {e}^{jk ( {md}_{y} sin θ sin φ + {nd}_{z} cos θ )} \vert}^{2} ) )$$

where [θ, φ]∈ target coverage area (e.g., a target radiation area), such as |φ|≤60° and 92°<θ<120°, P_{T} (θ, φ, Env (θ, φ)) corresponds to a candidate radiation pattern (e.g., as defined in equation (6)), and a is the pathloss compensation coefficient (e.g., a pre-configured pathloss aware parameter larger than 0, with a value such as 2 or 0.5). Optimized antenna beam weights for equation (10) may be defined as:

$${A}_{opt} = arg {max}_{{A}_{mn \_ P} , {A}_{mn \_ N}} ( J ( {A}_{mn \_ P} , {A}_{mn \_ N} ) ) \qquad ( 11 )$$

which may be subject to A_{mn_P}=e^{jϕ}^{_{mn_P}} and A_{mn_N}=: e^{jϕ}^{_{mn_N}}.

At 420, network entity 105-c may determine a set of antenna beamforming weights which are identified based on the beam pattern performance criterion. For instance, network entity 105-c may find the corresponding beamforming weights with an optimization problem solver. In some examples, the set of antenna beamforming weights correspond to the one of the set of candidate radiation patterns that has the pattern correlation coefficient that satisfies the threshold. For instance, the set of antenna beamforming weights may be determined according to equation (9), which may enable network entity 105-c to select antenna beamforming weights corresponding to a maximized pattern correlation coefficient (e.g., values of A_{mn_P} and A_{mn_N} that result in the maximized pattern correlation coefficient). In other examples, the set of antenna beamforming weights correspond to the one of the set of radiation patterns having the power gain value that satisfies the power gain threshold for the target coverage area. For instance, the set of antenna beamforming weights may be determined according to equation (11), which may enable network entity 105-c to select antenna beamforming weights corresponding to a maximized minimum power gain of a generated radiation pattern in a target coverage area (e.g., values of A_{mn_P} and A_{mn_N} that result in the maximized minimum power gain of a generated radiation pattern). A first subset of the set of antenna beamforming weights (e.g., each value of A_{mn_P} for various values of m and n) may be associated with a first polarization direction and a second subset of the set of antenna beamforming weights (e.g., each value of A_{mn_N} for various values of m and n) may be associated with a second polarization direction orthogonal to the first orthogonal direction. The antenna beamforming weights may be phase-only beamforming weights (e.g., the weights may not adjust an amplitude of the signal at each antenna element). In some examples, the set of candidate radiation patterns of the spatial envelope model are based on the set of pathloss values associated with the set of candidate geolocations.

At 425, network entity 105-c may transmit (e.g., via a wide transmission beam) a signal that is beamformed via the set of antenna elements of the antenna array of network entity 105-c (e.g., over the antenna elements at the mth and nth antenna element position). Using phase-only beamforming, which may enable network entity 105-c to achieve increased power amplifier efficiency (e.g., above a threshold amount), the antenna weights may have the following unit amplitude constraints: A_{mn_P}=e^{jϕ}^{_{mn_P}} and A_{mn_N}=e^{jϕ}^{_{mn_N}}. To reduce a dimension of the beam weights, the first beam weight may be restricted to a fixed value (e.g., A_{11_P}=1). A quantity of optimization solvers may be applied to deliver a sub-optimal solution for the above non-convex optimization problem (e.g., a pattern search algorithm or a multi-start based global optimization).

In some examples, the beam weight generation may be frequency dependent and may utilize a quantized frequency selection, which may reduce memory cost. For instance, in a wide system bandwidth, a set of frequencies can be preconfigured to generate beam weights corresponding to different frequencies while applying the closest frequency to pick the beam weights. In such examples, a synthesized beam pattern may be different depending on a frequency location a transmitted signal for a given beam weight vector or a given beam weight matrix applied on antenna elements of network entity 105-c. For instance, the frequency location may impact a wavenumber value in a power pattern function (e.g., in a candidate radiation pattern). Thus, when broadcast transmissions are transmitted at different candidate sync frequency positions in a frequency domain, different beam weights may be generated from an optimization solver. A set of frequency positions may be selected to cover an entire system frequency to generate different beam weights corresponding to different broadcast transmission frequency positions. If a broadcast transmission is transmitted outside of the set of broadcast transmission frequency positions, the beam weight corresponding to a closest broadcast transmission in the set may be selected or chosen, which may reduce memory cost.

In an example of frequency dependent beam weight generation, the signal may be transmitted via a first frequency band. In some such examples, network entity 105-c may transmit (e.g., via a second single and/or wide transmission beam) a second signal via a second frequency band that is beamformed via the set of antenna elements of the antenna array of network entity 105-c in accordance with a second set of antenna beamforming weights. The second set of antenna beamforming weights may be identified based on the beam pattern performance criterion applied to a second set of candidate radiation patterns of the spatial envelope model. Each candidate radiation pattern of the set of candidate radiation patterns may be associated with a first carrier wave and each candidate radiation pattern of the second set of candidate radiation patterns may be associated with a second carrier wave that is different from the first carrier wave. The signal may include or be an example of a broadcast transmission.

In some examples, the techniques described herein may be applied for multiple wide beams. For instance, a first wide beam of network entity 105-c may cover a first portion of a coverage area (e.g., a portion of a cell) and a second wide beam of network entity 105-c may cover a second portion of a coverage area (e.g., another portion of the cell). Network entity 105-c may determine a first set of beamforming weights for the first wide beam corresponding to the first portion of the coverage area and may determine a second set of beamforming weights for the second wide beam corresponding to the second portion of the coverage area. Respective beam pattern performance criteria may be applied to respective sets of candidate radiation patterns for each of the first and second wide beams in order to determine the first and second sets of beamforming weights, respectively. It should be noted that a greater quantity of wide beams may be contemplated without deviating from the scope of the present disclosure.

Utilizing a wide beam for a broadcast transmission may enable more evenly distributed antenna radiated power even for worst coverage UE locations within a target coverage cell with a wide coverage beam pattern (e.g., UE locations where the UE receives a broadcast transmission with a signal strength that meets or exceeds a threshold amount of power). The techniques described herein provide the worst coverage UEs in the cell with higher transmit beamforming gain compared with multiple narrow beams or other solutions. Additionally, enabling more targeted coverage for the wide beams may grant network entity 105-c a greater degree of flexibility in selecting between using multiple narrow beams or a reduced quantity of wide beams (e.g., a quantity of wide beams smaller than a quantity of narrow beams) in cases where either may meet a link budget.

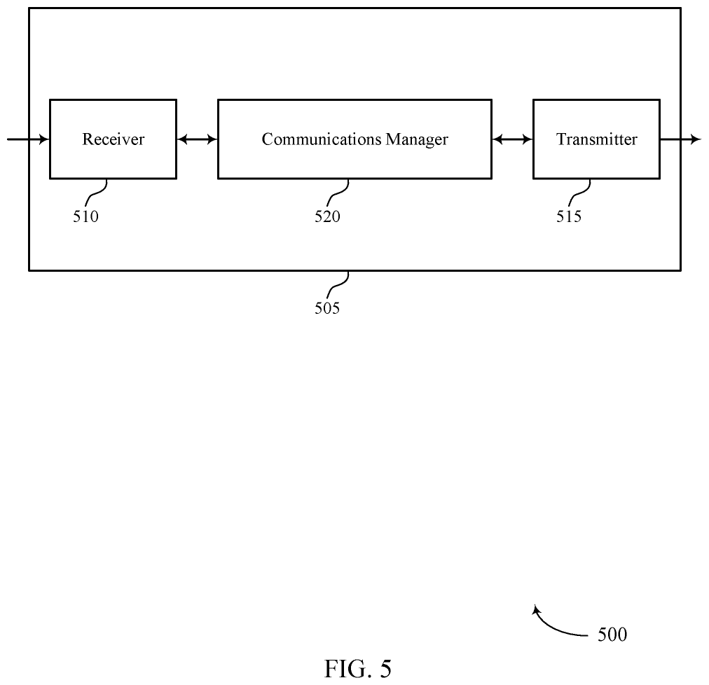

FIG. 5 shows a block diagram 500 of a device 505 that supports path loss aware beam pattern synthesis for wide coverage beams in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of path loss aware beam pattern synthesis for wide coverage beams as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control information indicating a set of multiple candidate geolocations within a target coverage area for the network entity. The communications manager 520 is capable of, configured to, or operable to support a means for transmitting (e.g., via a single transmission beam) a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for the device 505 to generate a wide beam with more targeted coverage for a broadcast transmission that has reduced power consumption and complexity as compared to a broadcast transmission over multiple beams.

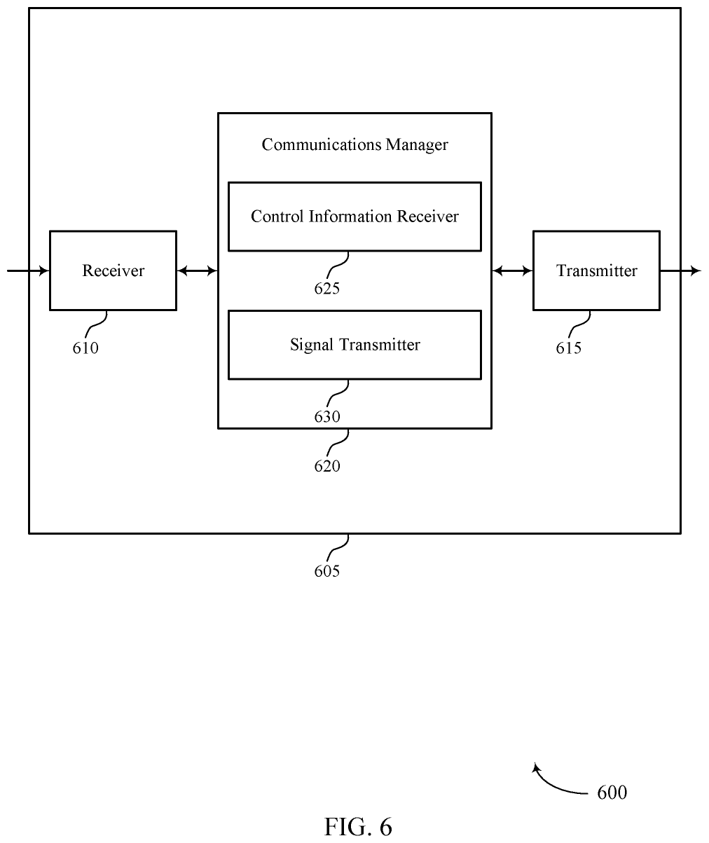

FIG. 6 shows a block diagram 600 of a device 605 that supports path loss aware beam pattern synthesis for wide coverage beams in accordance with one or more aspects of the present disclosure. The device 605 may be an example of aspects of a device 505 or a network entity 105 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of path loss aware beam pattern synthesis for wide coverage beams as described herein. For example, the communications manager 620 may include a control information receiver 625 a signal transmitter 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control information receiver 625 is capable of, configured to, or operable to support a means for receiving control information indicating a set of multiple candidate geolocations within a target coverage area for the network entity. The signal transmitter 630 is capable of, configured to, or operable to support a means for transmitting (e.g., via a single transmission beam) a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

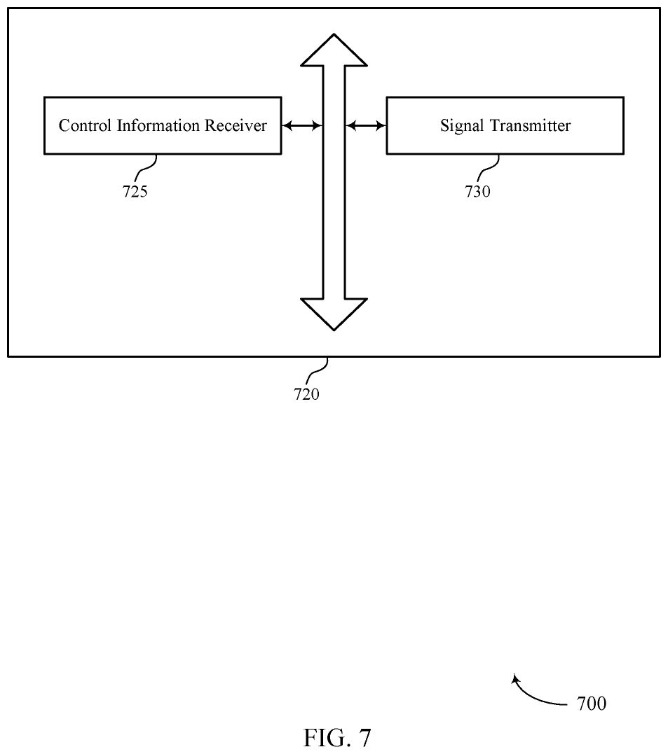

FIG. 7 shows a block diagram 700 of a communications manager 720 that supports path loss aware beam pattern synthesis for wide coverage beams in accordance with one or more aspects of the present disclosure. The communications manager 720 may be an example of aspects of a communications manager 520, a communications manager 620, or both, as described herein. The communications manager 720, or various components thereof, may be an example of means for performing various aspects of path loss aware beam pattern synthesis for wide coverage beams as described herein. For example, the communications manager 720 may include a control information receiver 725 a signal transmitter 730, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The control information receiver 725 is capable of, configured to, or operable to support a means for receiving control information indicating a set of multiple candidate geolocations within a target coverage area for the network entity. The signal transmitter 730 is capable of, configured to, or operable to support a means for transmitting (e.g., via a single transmission beam) a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

In some examples, a set of multiple pattern correlation coefficients are identified between a target radiation pattern for the target coverage area and a respective candidate radiation pattern of the set of multiple candidate radiation patterns. In some examples, the beam pattern performance criterion corresponds to one of the set of multiple candidate radiation patterns having a pattern correlation coefficient of the set of multiple pattern correlation coefficients that satisfies a threshold.

In some examples, the set of multiple antenna beamforming weights correspond to the one of the set of multiple candidate radiation patterns that has the pattern correlation coefficient that satisfies the threshold.

In some examples, the pattern correlation coefficient satisfying the threshold includes the pattern correlation coefficient being higher than each other pattern correlation coefficient of the set of multiple pattern correlation coefficients.

In some examples, a set of multiple power gain values are identified for the set of multiple candidate radiation patterns. In some examples, the beam pattern performance criterion corresponds to one of the set of multiple candidate radiation patterns having a power gain value of the set of multiple power gain values that satisfies a power gain threshold in the target coverage area.

In some examples, the set of multiple antenna beamforming weights correspond to the one of the set of multiple candidate radiation patterns having the power gain value that satisfies the power gain threshold for the target coverage area.

In some examples, each power gain value of the set of multiple power gain values corresponds to a minimum power gain value for a respective candidate radiation pattern in the target coverage area of the set of multiple candidate radiation patterns.

In some examples, the power gain value satisfying the power gain threshold includes the power gain value being higher than each other power gain value of the set of multiple power gain values.

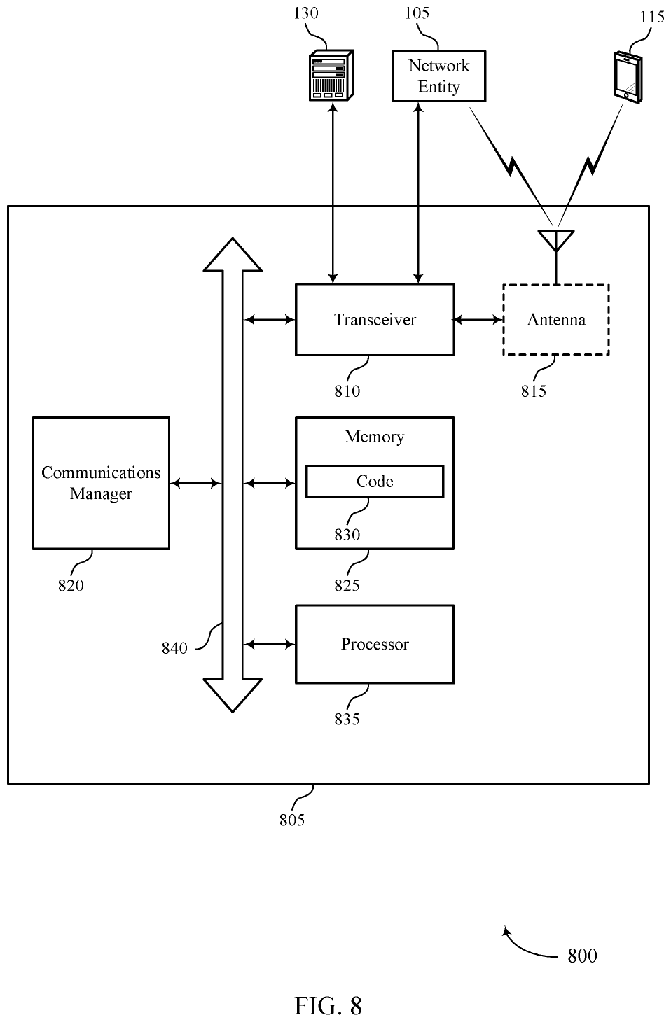

FIG. 8 shows a diagram of a system 800 including a device 805 that supports path loss aware beam pattern synthesis for wide coverage beams in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting path loss aware beam pattern synthesis for wide coverage beams). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. As such, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving control information indicating a set of multiple candidate geolocations within a target coverage area for the network entity. The communications manager 820 is capable of, configured to, or operable to support a means for transmitting (e.g., via a single transmission beam) a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations.

By including or configuring the communications manager 820 in accordance with examples as described herein, the device 805 may support techniques for the device 805 to generate a wide beam with more targeted coverage for a broadcast transmission that has reduced power consumption and complexity as compared to a broadcast transmission over multiple beams.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of path loss aware beam pattern synthesis for wide coverage beams as described herein, or the at least one processor 835 and the at least one memory 825 may be otherwise configured to, individually or collectively, perform or support such operations.

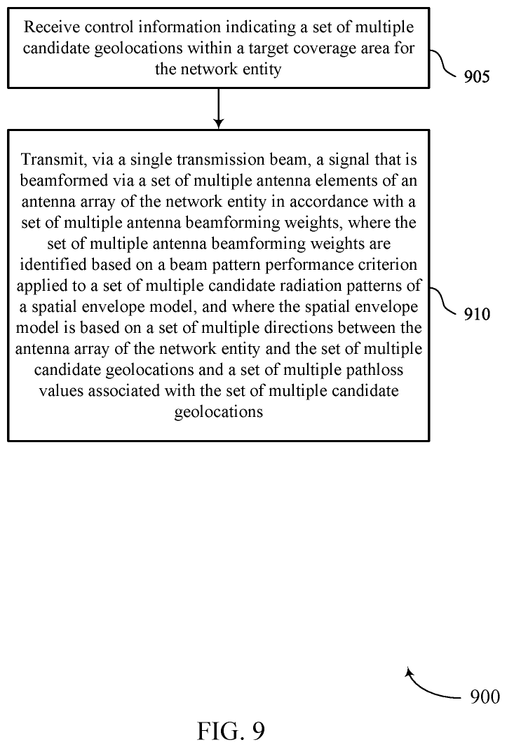

FIG. 9 shows a flowchart illustrating a method 900 that supports path loss aware beam pattern synthesis for wide coverage beams in accordance with aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include receiving control information indicating a set of multiple candidate geolocations within a target coverage area for the network entity. The operations of 905 may be performed in accordance with examples as disclosed herein. In some examples, aspects of the operations of 905 may be performed by a control information receiver 725 as described with reference to FIG. 7.

At 910, the method may include transmitting a signal that is beamformed via a set of multiple antenna elements of an antenna array of the network entity in accordance with a set of multiple antenna beamforming weights, where the set of multiple antenna beamforming weights are identified based on a beam pattern performance criterion applied to a set of multiple candidate radiation patterns of a spatial envelope model, and where the spatial envelope model is based on a set of multiple directions between the antenna array of the network entity and the set of multiple candidate geolocations and a set of multiple pathloss values associated with the set of multiple candidate geolocations. The operations of 910 may be performed in accordance with examples as disclosed herein. In some examples, aspects of the operations of 910 may be performed by a signal transmitter 730 as described with reference to FIG. 7.

The following provides an overview of aspects of the present disclosure:

Aspect 1: A method for wireless communications at a network entity, comprising: receiving control information indicating a plurality of candidate geolocations within a target coverage area for the network entity; and transmitting a signal that is beamformed via a plurality of antenna elements of an antenna array of the network entity in accordance with a plurality of antenna beamforming weights, wherein the plurality of antenna beamforming weights are identified based at least in part on a beam pattern performance criterion applied to a plurality of candidate radiation patterns of a spatial envelope model, and wherein the spatial envelope model is based at least in part on a plurality of directions between the antenna array of the network entity and the plurality of candidate geolocations and a plurality of pathloss values associated with the plurality of candidate geolocations.

Aspect 2: The method of aspect 1, wherein a plurality of pattern correlation coefficients are identified between a target radiation pattern for the target coverage area and a respective candidate radiation pattern of the plurality of candidate radiation patterns, and the beam pattern performance criterion corresponds to one of the plurality of candidate radiation patterns having a pattern correlation coefficient of the plurality of pattern correlation coefficients that satisfies a threshold.

Aspect 3: The method of aspect 2, wherein the plurality of antenna beamforming weights correspond to the one of the plurality of candidate radiation patterns that has the pattern correlation coefficient that satisfies the threshold.

Aspect 4: The method of any of aspects 2 through 3, wherein the pattern correlation coefficient satisfying the threshold comprises the pattern correlation coefficient being higher than each other pattern correlation coefficient of the plurality of pattern correlation coefficients.

Aspect 5: The method of any of aspects 1 through 4, wherein a plurality of power gain values are identified for the plurality of candidate radiation patterns, and the beam pattern performance criterion corresponds to one of the plurality of candidate radiation patterns having a power gain value of the plurality of power gain values that satisfies a power gain threshold in the target coverage area.

Aspect 6: The method of aspect 5, wherein the plurality of antenna beamforming weights correspond to the one of the plurality of candidate radiation patterns having the power gain value that satisfies the power gain threshold for the target coverage area.

Aspect 7: The method of any of aspects 5 through 6, wherein each power gain value of the plurality of power gain values corresponds to a minimum power gain value for a respective candidate radiation pattern in the target coverage area of the plurality of candidate radiation patterns.

Aspect 8: The method of any of aspects 5 through 7, wherein the power gain value satisfying the power gain threshold comprises the power gain value being higher than each other power gain value of the plurality of power gain values.

Aspect 9: The method of any of aspects 1 through 8, wherein the signal is transmitted via a first frequency band, the method further comprising: transmitting a second signal via a second frequency band that is beamformed via the plurality of antenna elements of the antenna array of the network entity in accordance with a second plurality of antenna beamforming weights, wherein the second plurality of antenna beamforming weights are identified based at least in part on the beam pattern performance criterion applied to a second plurality of candidate radiation patterns of the spatial envelope model.

Aspect 10: The method of aspect 9, wherein each candidate radiation pattern of the plurality of candidate radiation patterns is associated with a first carrier wave and each candidate radiation pattern of the second plurality of candidate radiation patterns is associated with a second carrier wave that is different from the first carrier wave.

Aspect 11: The method of any of aspects 1 through 10, wherein the spatial envelope model is based at least in part on a pathloss compensation coefficient that indicates the plurality of pathloss values associated with the plurality of candidate geolocations.

Aspect 12: The method of any of aspects 1 through 11, wherein the plurality of candidate radiation patterns of the spatial envelope model are based at least in part on the plurality of pathloss values associated with the plurality of candidate geolocations.

Aspect 13: A network entity for wireless communications, comprising one or more memories storing processor-executable code, and one or more processors coupled with the one or more memories and individually or collectively operable to execute the code to cause the network entity to perform a method of any of aspects 1 through 12.

Aspect 14: A network entity for wireless communications, comprising at least one means for performing a method of any of aspects 1 through 12.

Aspect 15: A non-transitory computer-readable medium storing code for wireless communications, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
receive control information indicating a plurality of candidate geolocations within a target coverage area for the network entity; and
transmit a signal that is beamformed via a plurality of antenna elements of an antenna array of the network entity in accordance with a plurality of antenna beamforming weights, wherein the plurality of antenna beamforming weights are identified based at least in part on a beam pattern performance criterion applied to a plurality of candidate radiation patterns of a spatial envelope model, and wherein the spatial envelope model is based at least in part on a plurality of directions between the antenna array of the network entity and the plurality of candidate geolocations and a plurality of pathloss values associated with the plurality of candidate geolocations.

2. The network entity of claim 1, wherein:
a plurality of pattern correlation coefficients are identified between a target radiation pattern for the target coverage area and a respective candidate radiation pattern of the plurality of candidate radiation patterns, and
the beam pattern performance criterion corresponds to one of the plurality of candidate radiation patterns having a pattern correlation coefficient of the plurality of pattern correlation coefficients that satisfies a threshold.

3. The network entity of claim 2, wherein the plurality of antenna beamforming weights correspond to the one of the plurality of candidate radiation patterns that has the pattern correlation coefficient that satisfies the threshold.

4. The network entity of claim 2, wherein the pattern correlation coefficient satisfying the threshold comprises the pattern correlation coefficient being higher than each other pattern correlation coefficient of the plurality of pattern correlation coefficients.

5. The network entity of claim 1, wherein:
a plurality of power gain values are identified for the plurality of candidate radiation patterns, and
the beam pattern performance criterion corresponds to one of the plurality of candidate radiation patterns having a power gain value of the plurality of power gain values that satisfies a power gain threshold in the target coverage area.

6. The network entity of claim 5, wherein the plurality of antenna beamforming weights correspond to the one of the plurality of candidate radiation patterns having the power gain value that satisfies the power gain threshold for the target coverage area.

7. The network entity of claim 5, wherein each power gain value of the plurality of power gain values corresponds to a minimum power gain value for a respective candidate radiation pattern in the target coverage area of the plurality of candidate radiation patterns.

8. The network entity of claim 5, wherein the power gain value satisfying the power gain threshold comprises the power gain value being higher than each other power gain value of the plurality of power gain values.

9. The network entity of claim 1, wherein the signal is transmitted via a first frequency band, and the one or more processors are individually or collectively further operable to execute the code to cause the network entity to:
transmit a second signal via a second frequency band that is beamformed via the plurality of antenna elements of the antenna array of the network entity in accordance with a second plurality of antenna beamforming weights, wherein the second plurality of antenna beamforming weights are identified based at least in part on the beam pattern performance criterion applied to a second plurality of candidate radiation patterns of the spatial envelope model.

10. The network entity of claim 9, wherein each candidate radiation pattern of the plurality of candidate radiation patterns is associated with a first carrier wave and each candidate radiation pattern of the second plurality of candidate radiation patterns is associated with a second carrier wave that is different from the first carrier wave.

11. The network entity of claim 1, wherein the spatial envelope model is based at least in part on a pathloss compensation coefficient that indicates the plurality of pathloss values associated with the plurality of candidate geolocations.

12. The network entity of claim 1, wherein the plurality of candidate radiation patterns of the spatial envelope model are based at least in part on the plurality of pathloss values associated with the plurality of candidate geolocations.

13. The network entity of claim 1, wherein each candidate geolocation within the plurality of candidate geolocations corresponds to a maximum distance or a maximum range of a plurality of user equipment (UEs) relative to the antenna array for a respective direction of the plurality of directions.

14. The network entity of claim 1, wherein a first subset of the plurality of antenna beamforming weights is associated with a first polarization direction and a second subset of the plurality of antenna beamforming weights is associated with a second polarization direction orthogonal to the first polarization direction.

15. The network entity of claim 1, wherein the signal comprises a broadcast transmission.

16. A method for wireless communications at a network entity, comprising:
receiving control information indicating a plurality of candidate geolocations within a target coverage area for the network entity; and
transmitting a signal that is beamformed via a plurality of antenna elements of an antenna array of the network entity in accordance with a plurality of antenna beamforming weights, wherein the plurality of antenna beamforming weights are identified based at least in part on a beam pattern performance criterion applied to a plurality of candidate radiation patterns of a spatial envelope model, and wherein the spatial envelope model is based at least in part on a plurality of directions between the antenna array of the network entity and the plurality of candidate geolocations and a plurality of pathloss values associated with the plurality of candidate geolocations.

17. The method of claim 16, wherein:
a plurality of pattern correlation coefficients are identified between a target radiation pattern for the target coverage area and a respective candidate radiation pattern of the plurality of candidate radiation patterns, and
the beam pattern performance criterion corresponds to one of the plurality of candidate radiation patterns having a pattern correlation coefficient of the plurality of pattern correlation coefficients that satisfies a threshold.

18. The method of claim 17, wherein the plurality of antenna beamforming weights correspond to the one of the plurality of candidate radiation patterns that has the pattern correlation coefficient that satisfies the threshold.

19. The method of claim 17, wherein the pattern correlation coefficient satisfying the threshold comprises the pattern correlation coefficient being higher than each other pattern correlation coefficient of the plurality of pattern correlation coefficients.

20. The method of claim 16, wherein:
a plurality of power gain values are identified for the plurality of candidate radiation patterns, and
the beam pattern performance criterion corresponds to one of the plurality of candidate radiation patterns having a power gain value of the plurality of power gain values that satisfies a power gain threshold in the target coverage area.

21. The method of claim 20, wherein the plurality of antenna beamforming weights correspond to the one of the plurality of candidate radiation patterns having the power gain value that satisfies the power gain threshold for the target coverage area.

22. The method of claim 20, wherein each power gain value of the plurality of power gain values corresponds to a minimum power gain value for a respective candidate radiation pattern in the target coverage area of the plurality of candidate radiation patterns.

23. The method of claim 20, wherein the power gain value satisfying the power gain threshold comprises the power gain value being higher than each other power gain value of the plurality of power gain values.

24. The method of claim 16, wherein the signal is transmitted via a first frequency band, the method further comprising:
transmitting a second signal via a second frequency band that is beamformed via the plurality of antenna elements of the antenna array of the network entity in accordance with a second plurality of antenna beamforming weights, wherein the second plurality of antenna beamforming weights are identified based at least in part on the beam pattern performance criterion applied to a second plurality of candidate radiation patterns of the spatial envelope model.

25. The method of claim 24, wherein each candidate radiation pattern of the plurality of candidate radiation patterns is associated with a first carrier wave and each candidate radiation pattern of the second plurality of candidate radiation patterns is associated with a second carrier wave that is different from the first carrier wave.

26. The method of claim 16, wherein the spatial envelope model is based at least in part on a pathloss compensation coefficient that indicates the plurality of pathloss values associated with the plurality of candidate geolocations.

27. The method of claim 16, wherein the plurality of candidate radiation patterns of the spatial envelope model are based at least in part on the plurality of pathloss values associated with the plurality of candidate geolocations.

28. The method of claim 16, wherein each candidate geolocation within the plurality of candidate geolocations corresponds to a maximum distance or a maximum range of a plurality of user equipment (UEs) relative to the antenna array for a respective direction of the plurality of directions.

29. A network entity for wireless communications, comprising:
means for receiving control information indicating a plurality of candidate geolocations within a target coverage area for the network entity; and
means for transmitting a signal that is beamformed via a plurality of antenna elements of an antenna array of the network entity in accordance with a plurality of antenna beamforming weights, wherein the plurality of antenna beamforming weights are identified based at least in part on a beam pattern performance criterion applied to a plurality of candidate radiation patterns of a spatial envelope model, and wherein the spatial envelope model is based at least in part on a plurality of directions between the antenna array of the network entity and the plurality of candidate geolocations and a plurality of pathloss values associated with the plurality of candidate geolocations.

30. A non-transitory computer-readable medium storing code for wireless communications at a network entity, the code comprising instructions executable by one or more processors to:
receive control information indicating a plurality of candidate geolocations within a target coverage area for the network entity; and
transmit a signal that is beamformed via a plurality of antenna elements of an antenna array of the network entity in accordance with a plurality of antenna beamforming weights, wherein the plurality of antenna beamforming weights are identified based at least in part on a beam pattern performance criterion applied to a plurality of candidate radiation patterns of a spatial envelope model, and wherein the spatial envelope model is based at least in part on a plurality of directions between the antenna array of the network entity and the plurality of candidate geolocations and a plurality of pathloss values associated with the plurality of candidate geolocations.
